(19) United States
(12) Patent Application Publication
(10) Pub. No.: US 2014/0324760 A1
(43) Pub. Date: Oct. 30, 2014

(54) SYNTHETIC TIME SERIES DATA GENERATION

(71) Applicant: HEWLETT-PACKARD DEVELOPMENT COMPANY, L.P., Houston, TX (US)

(72) Inventors: Manish MARWAH, Palo Alto, CA (US); Martin Arlitt, Calgary (CA); Amip J. Shah, Santa Clara, CA (US); Cullen E. Bash, Los Gatos, CA (US)

(73) Assignee: Hewlett-Packard Development Company, L.P., Houston, TX (US)

(21) Appl. No.: 13/874,254

(22) Filed: Apr. 30, 2013

(51) Int. Cl. G06N 7/00

(52) U.S. Cl. CPC G06N 7/00
USPC 706/52

(57) ABSTRACT

According to an example, synthetic time series data generation may include receiving empirical meter data for a plurality of users, and using the empirical meter data to estimate parameters of a Markov chain. The Markov chain may be used to generate the synthetic time series data having statistical properties similar to the statistical properties of the empirical meter data.

### BACKGROUND

A variety of devices record data in predetermined intervals over a predetermined duration. For example, smart meters typically record resource consumption in predetermined intervals (e.g., monthly, hourly, etc.), and communicate the recorded consumption information to a utility for monitoring, evaluation, and billing purposes. The recorded time series data is typically analyzed, for example, by a data management system, to optimize aspects related to electric energy usage, power resources, etc.

### BRIEF DESCRIPTION OF DRAWINGS

Features of the present disclosure are illustrated by way of example and not limited in the following figure(s), in which like numerals indicate like elements, in which:

FIG. 1 illustrates an architecture of a synthetic time series data generation apparatus, according to an example of the present disclosure;

FIG. 2 illustrates a Markov chain of consumption states, according to an example of the present disclosure;

FIG. 3 illustrates a transition probability matrix, according to an example of the present disclosure;

FIG. 4 illustrates an augmented Markov chain, according to an example of the present disclosure;

FIG. 5 illustrates a method for synthetic time series data generation, according to an example of the present disclosure;

FIG. 6 illustrates further details of the method for synthetic time series data generation, according to an example of the present disclosure; and

FIG. 7 illustrates a computer system, according to an example of the present disclosure.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

For smart meters that typically record data related to consumption of resources such as electricity, gas, water, etc., sensory data related to motion, traffic, etc., or other types of time series data, analysis of such time series data may be performed by a data management system. The scope of such analysis can be limited, for example, based on the availability of empirical (i.e., real) time series data. Moreover, performance testing of such data management systems at scale can be challenging due to the unavailability of large amounts of empirical time series data (e.g., data for tens to hundreds of millions of users). In order to generate such large amounts of time series data, a comparably smaller amount of empirical time series data may be replicated with appropriate changes to data fields such as meter IDs and timestamps. Alternatively, entirely synthetic datasets may be used. For example, although fields such as meter IDs may be realistically generated, time series data values may be randomly generated. Such techniques for generation of large amounts of synthetic data can negatively impact the accuracy of the performance testing of the data management systems. For example, if the synthetic data is generated by duplicating empirical data, a very high degree of data compression may result. On the other hand, if the synthetic data is completely random, data compression is likely to be poorer than in an empirical data set.

According to an example, a synthetic time series data generation apparatus and a method for synthetic time series data generation are disclosed herein. For the apparatus and method disclosed herein, synthetic time series data may be generated by using a relatively small set of an empirical smart meter dataset such that the synthetic time series data has similar statistical properties to those of the small empirical smart meter dataset. The synthetic time series data may be used for performance and scalability testing, for example, for data management systems.

Generally, for the apparatus and method disclosed herein, time series data may be approximated by a finite number of states and modeled using a Markov chain. More particularly, empirical meter data may be used to estimate parameters of the Markov chain. Further, the Markov chain may be used to generate the synthetic time series data.

For the apparatus and method disclosed herein, any amount of synthetic time series data may be generated based on a relatively small amount of empirical data. For example, time series data for any number of users may be generated, given such time series data for a limited number of users (i.e., a real time series), such that the statistical properties of the generated time series data is similar to the real time series data. The empirical data may include, for example, time series data measurements for resources such as electricity, gas, water, etc. The synthetic time series data may be used, for example, for scalability and performance testing of data management and analytics solutions. Further, the synthetic time series data may generally retain the properties of the limited amount of empirical data used to derive the parameters of the synthetic time series data model used to generate the synthetic time series data.

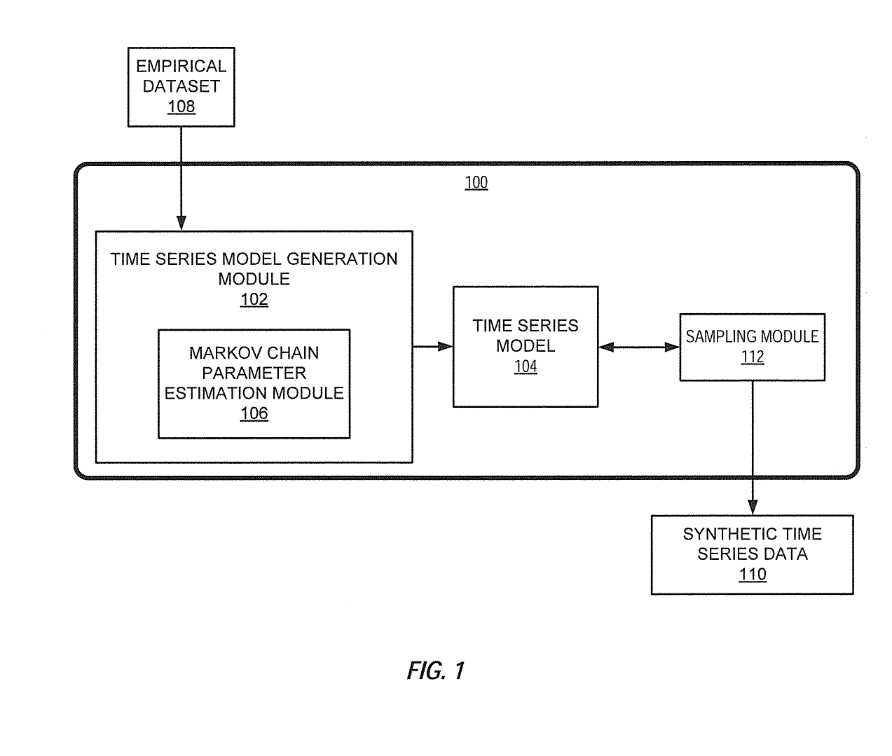

FIG. 1 illustrates an architecture of a synthetic time series data (STSD) generation apparatus 100, according to an example. Referring to FIG. 1, the apparatus 100 is depicted as including a time series model generation module 102 to generate a time series model 104. The time series model generation module 102 may include a Markov chain parameter estimation module 106 to receive an empirical dataset 108 and to use the empirical dataset 108 to estimate parameters of the Markov chain. Therefore, the time series model 104 may include the Markov chain. In order to generate the STSD 110 using the time series model 104, a sampling module 112 may pick an initial state in the Markov chain and generate a synthetic time series value by generating states of the chain and sampling a corresponding probability density function (PDF) within each state.

The modules 102, 106, and 112, and other components of the apparatus 100 that perform various other functions in the apparatus 100, may include machine readable instructions stored on a non-transitory computer readable medium. In addition, or alternatively, the modules 102, 106, and 112, and other components of the apparatus 100 may include hardware or a combination of machine readable instructions and hardware.

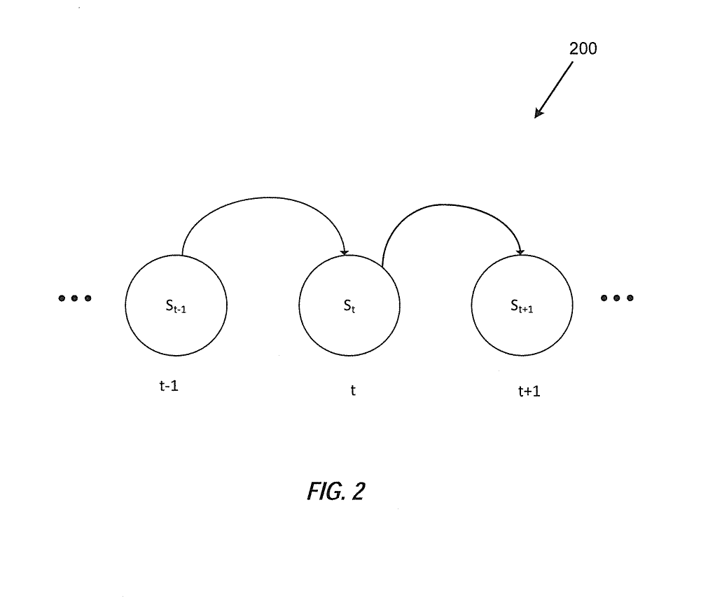

Referring to FIGS. 1 and 2, FIG. 2 illustrates a Markov chain 200 of consumption states, according to an example of the present disclosure. The Markov chain parameter estimation module 106 may estimate the parameters of the Markov chain 200 by first receiving the empirical dataset 108 that includes user time series (e.g., x₁, x₂, x₃ . . . ), where xᵢ may represent, for example, monthly time series (or a time series at any frequency). The Markov chain parameter estimation module 106 may discretize the time series into a predetermined number of bins (i.e., states) n. For example, the Markov chain parameter estimation module 106 may use fixed-width binning to discretize the time series. The discretization may transform the time series into a series of discrete levels or states. Each time series may be considered as a Markov chain 200. For FIG. 2, a current state at time t may be designated as Sₜ, a previous state at time t−1 may be designated as Sₜ₋₁, and a next state at time t+1 may be designated as Sₜ₊₁.

According to an example, for an empirical dataset 108 that includes user time series x₁=0.10 kW, x₂=0.15 kW, x₃=0.18 kW, etc., these time series values may be discretized into twenty states (i.e., n=20). For example, a state-1 may be assigned to time series values between 0.10 and 0.11 kW, a state-2 may be assigned to time series values between 0.11 and 0.12 kW, etc. In this manner, the Markov chain parameter estimation module 106 may use fixed-width binning to discretize the time series. Other methods of discretization may include, for example, equal frequency binning where each bin has the same number of points. Moreover, a hybrid method of discretization may also be used where initially fixed width-binning is used, and bins with very few data points are merged with their neighbors.

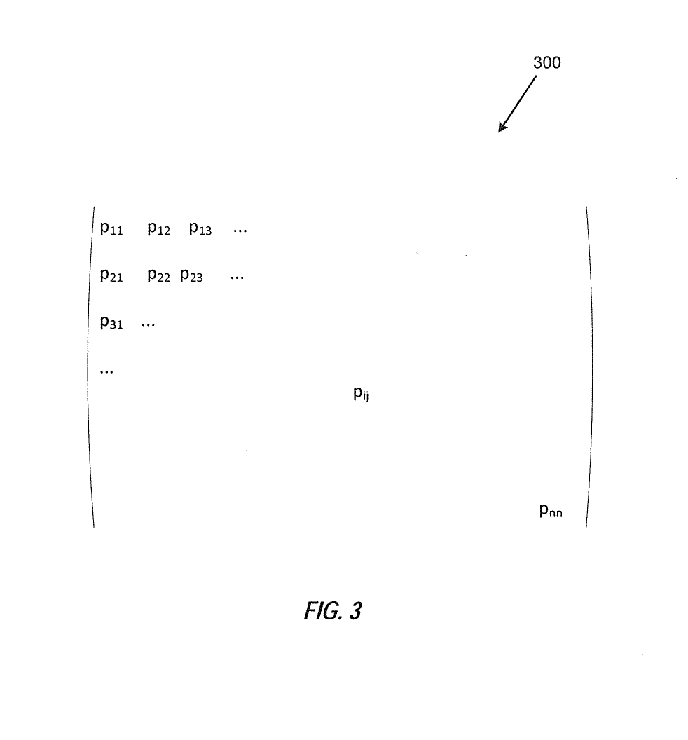

Referring to FIGS. 1 and 3, FIG. 3 illustrates a transition probability matrix 300, according to an example of the present disclosure. A maximum likelihood estimation (MLE) may be used to estimate the transition probability matrix 300 of the Markov chain 200 from the empirical dataset 108. The transition probability matrix 300 may be an n×n matrix, where entry (i, j) of the transition probability matrix 300 corresponds to the transition probability from state i to state j, that is, the conditional probability, Pr(Sₜ₊₁=j|Sₜ=i). For example, for the foregoing example of n=20 states, the transition probability matrix 300 may be a 20×20 matrix, where entry (i, j) corresponds to the transition probability from state i (e.g., state-1, state-2, etc.) to state j (e.g., state-1, state-2, etc.). Further, for the transition probability matrix 300, the probability of transitioning from a state at time t (i.e., Sₜ) to the next state at time t+1 (i.e., Sₜ₊₁), depends on the previous state at time t−1 (i.e., Sₜ₋₁). Each row of the transition probability matrix 300 sums to 1. The MLE of the transition probability matrix 300 may reduce to counting all occurrences of transitions in the time series (i.e., empirical dataset 108) and then normalizing the counts. The counts may therefore represent a number of transitions between different states for all users for the empirical dataset 108 that are used to define the transition probability matrix 300.

With respect to the transition probability matrix 300, in certain cases, there may not be any data available for several transitions, or in other words, the transition probability matrix 300 may be sparse. To address sparsity, the Markov chain parameter estimation module 106 may use Laplace smoothing, whereby the count for each transition is increased by one. For example, for an n×n transition probability matrix 300, if n is large, the transition probability matrix 300 may include probabilities without any transitions (e.g., probability=0). For such probabilities, the Markov chain parameter estimation module 106 may use Laplace smoothing, whereby the count for each transition is increased by one, and thus there are no transition probabilities with zero value.

The Markov chain parameter estimation module 106 may also estimate the stationary (i.e., the probability of remaining in a particular state, or steady state) probabilities of the Markov chain 200. The stationary (or steady state) probabilities may be estimated directly from the empirical dataset 108, or by computing the eigenvector corresponding to an eigenvalue of 1 of the estimated transition probability matrix 300. The stationary probabilities for each state may correspond to the average time spent in that state in the time series.

For each state, the Markov chain parameter estimation module 106 may use a kernel density estimate to compute the probability density function (PDF) corresponding to that state. The estimated PDF, f, at any point x, may be expressed as follows:

$${f}_{h} ( x ) = \frac{1}{mh} {\sum }_{i = 1}^{m} K ( \frac{x - {x}_{i}}{h} ) \qquad Equation ( 1 )$$

For Equation (2), h may represent the selected bandwidth, m may represent the total number of points, K may represent the selected kernel, and xᵢ may represent the points that fall within that state. For example, for the foregoing example, if state-1 has consumption values from 0.10 to 0.11 kW, m may represent the total number of points that lie within this range. With respect to the selected bandwidth h, increasing h may similarly increase smoothness of the PDF. For Equation (2), a Gaussian kernel may be used. However, other kernels such as uniform, triangular, biweight, triweight, Epanechnikov, etc., may be used. If the number of points, m, is large, a binned kernel density estimate may be used.

In order to generate the STSD 110 using the time series model 104, the sampling module 112 may use the Markov chain 200. More particularly, the sampling module 112 may pick (i.e., select) an initial state in the Markov chain randomly. The state may be picked based on the stationary probability mass function of the states. Each subsequent state may be picked based on the transition probability matrix 300. For example, for the foregoing example, if an initial state of ten (i.e., state-10) is randomly selected, each subsequent state may be selected based on the transition probability matrix 300. When a particular state is selected, a time series value may be generated by sampling the corresponding PDF (i.e., Equation (1)). To facilitate this process, the sampling module 112 may also pre-sample a large number of points (e.g., 100,000) from the PDF of each state and save these points. In this case, sampling the PDF may reduce to sampling a random number from a uniform distribution, and using the random number to select a consumption value from the population of pre-sampled points. The process of picking each subsequent state and generating a time series value may be repeated depending on the length needed for the generated time series. In this manner, the number of generated time series values may exceed the original number of such values in the empirical dataset 108 such that the STSD 110 may generally retain the properties of the limited empirical dataset 108.

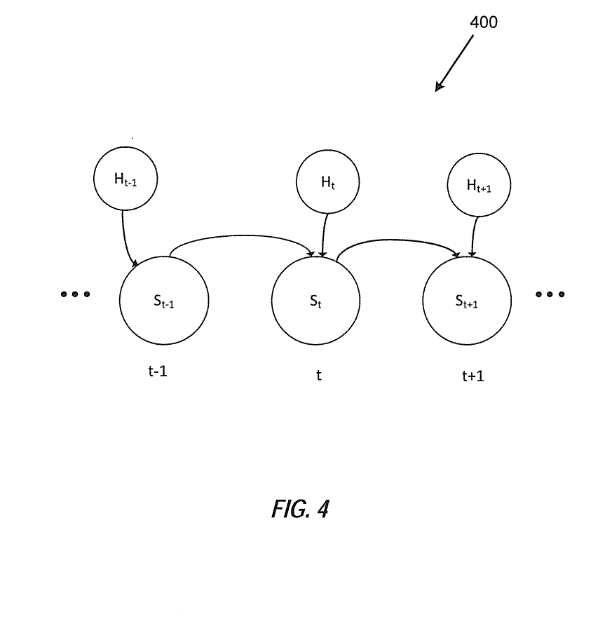

Referring to FIGS. 1 and 4, FIG. 4 illustrates an augmented Markov chain 400, according to an example of the present disclosure. Other factors such as the hour of day may also be included in the Markov chain 200, resulting in the augmented Markov chain 400. Instead of or in addition to hours, other factors such as days, months, etc., or non-time related factors such as weather, etc., may also be included in the augmented Markov chain 400. Further, multiple factors may also be included in the augmented Markov chain 400 as being related to the states. Compared to the Markov chain 200, for the example of the augmented Markov chain 400 of FIG. 4, the transition to the next state may also depend on the current hour (where the number distinct values of hour is m (which, e.g., for a day will be 24)) in addition to the current state. The augmented Markov chain 400 may include a three-dimensional transition probability matrix compared to the two-dimensional transition probability matrix 300 for the Markov chain 200. As discussed herein, the transition probability matrix 300 may be an n×n matrix, where entry (i, j) corresponds to the transition probability from state i to state j, that is, the conditional probability, Pr(Sₜ₊₁=j|Sₜ=i). The augmented Markov chain 400 may include a transition probability expression of Pr(Sₜ₊₁=j|Sₜ=i, Hₜ₊₁=h), and an n×n×m transition matrix (where m is the number of hours considered). As this may result in greater sparsity, the transitional probability may be factored as follows (using the assumption that given the next state (Sₜ₊₁=j), the current state (Sₜ=i) and next hour (Hₜ₊₁=h) are conditionally independent):

Pr(Sₜ₊₁=j|Sₜ=i,Hₜ₊₁=h)∝P(Sₜ=i,Hₜ₊₁=h|Sₜ₊₁=j)P(Sₜ₊₁=j)∝P(Sₜ=i|Sₜ₊₁=j)P(Hₜ₊₁=h|Sₜ₊₁=j)P(Sₜ₊₁=j) Equation (2)

For Equation (2), the addition of the hour (H) is shown in the transition probability expression of Pr(Sₜ₊₁=j|Sₜ=i, Hₜ₊₁=h). As mentioned above, the dimensionality of the transition probability matrix is n×n×m, that is, these many distinct parameters need to be estimated from the real data. By performing the above factorization of the probability expression on the left hand side, the number of parameters that need to be estimated is reduced. The left hand side of Equation (2) may need estimation of n²m parameters, and the right hand side of Equation (2) may need estimation of n²+mn+n parameters. Therefore, by factoring the transitional probability as shown, the number of parameters to be estimated from data Equation (2) may be reduced. For example, for the foregoing example of n=20, and for m=24, the left hand side of Equation (2) may include a dimensionality of n² m=9,600, and the right hand side of Equation (2) may include a dimensionality of n²+mn+n=900. For Equation (2), the right hand side may be normalized to obtain the corresponding probabilities. Furthermore, since individual probability values of terms in Equation (2) may be very low, they may cause numerical underflow when multiplied. In order to address this, the probability values may be transformed by taking their logarithms and then added, that is, Equation (2) changes to:

Log(Pr(Sₜ₊₁=j|Sₜ=i,Hₜ₊₁=h))∝Log(P(Sₜ=i|Sₜ₊₁=j))+Log(P(Hₜ₊₁=h|Sₜ₊₁=j))+Log(P(Sₜ₊₁=j)).

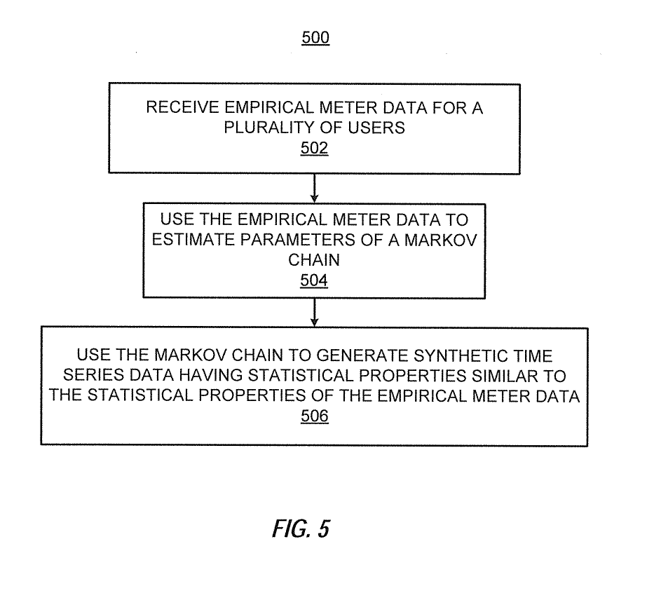

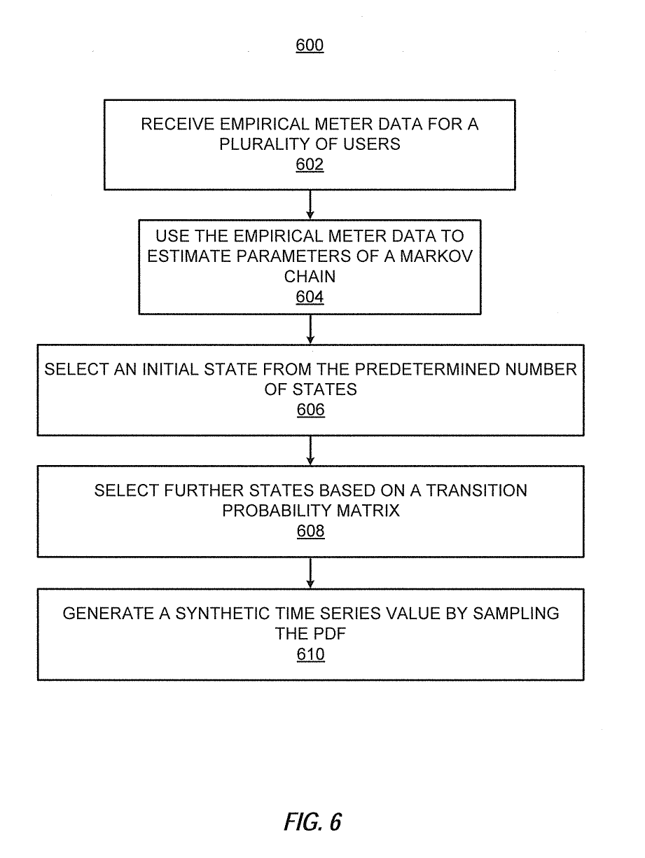

FIGS. 5 and 6 respectively illustrate flowcharts of methods 500 and 600 for synthetic time series data (STSD) generation, corresponding to the example of the STSD generation apparatus 100 whose construction is described in detail above. The methods 500 and 600 may be implemented on the STSD generation apparatus 100 with reference to FIG. 1 by way of example and not limitation. The methods 500 and 600 may be practiced in other apparatus.

Referring to FIG. 5, for the method 500, at block 502, empirical meter data may be received for a plurality of users. For example, referring to FIG. 1, the Markov chain parameter estimation module 106 may receive the empirical dataset 108.

At block 504, the empirical meter data may be used to estimate parameters of a Markov chain. For example, referring to FIG. 1, the Markov chain parameter estimation module 106 may receive the empirical dataset 108 and may use the empirical dataset 108 to estimate parameters of the Markov chain.

At block 506, the Markov chain may be used to generate the synthetic time series data having statistical properties similar to the statistical properties of the empirical meter data. For example, referring to FIG. 1, the sampling module 112 may pick an initial state in the Markov chain and generate a synthetic time series value by generating states of the Markov chain and sampling a corresponding PDF within each state.

Referring to FIG. 6, for the method 600, at block 602, empirical meter data may be received for a plurality of users.

At block 604, the empirical meter data may be used to estimate parameters of a Markov chain. Using the empirical meter data to estimate parameters of the Markov chain may include discretizing the empirical meter data into a predetermined number of states. A MLE may be used to estimate a transition probability matrix of the Markov chain from the empirical meter data. Laplace smoothing may be used to address sparsity in the transition probability matrix. Stationary probabilities of the Markov chain may be estimated. The stationary probabilities for each state of the predetermined number of states may correspond to an average time spent in the state. For each state of the predetermined number of states, a density estimate (e.g., a kernel density estimate, or a binned kernel density estimate) may be used to compute a PDF corresponding to the state.

At block 606, an initial state may be selected (e.g., randomly) from the predetermined number of states to generate the synthetic time series data. For example, referring to FIGS. 1 and 2, the sampling module 112 may select (e.g., randomly) an initial state from the predetermined number of states of the Markov chain 200.

At block 608, further states may be selected based on the transition probability matrix. For example, referring to FIGS. 1 and 3, the sampling module 112 may select further states based on the transition probability matrix 300.

At block 610, a synthetic time series value may be generated by sampling the PDF. For example, referring to FIG. 1, a synthetic time series value (i.e., a value of the STSD 110) may be generated by sampling the PDF (e.g., Equation (1)).

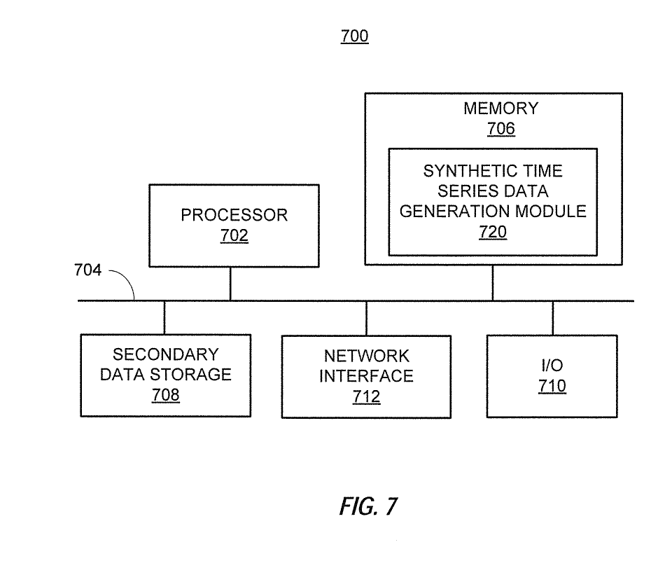

FIG. 7 shows a computer system 700 that may be used with the examples described herein. The computer system represents a generic platform that includes components that may be in a server or another computer system. The computer system 700 may be used as a platform for the apparatus 100. The computer system 700 may execute, by a processor or other hardware processing circuit, the methods, functions and other processes described herein. These methods, functions and other processes may be embodied as machine readable instructions stored on a computer readable medium, which may be non-transitory, such as hardware storage devices (e.g., RAM (random access memory), ROM (read only memory), EPROM (erasable, programmable ROM), EEPROM (electrically erasable, programmable ROM), hard drives, memristors, and flash memory).

The computer system 700 includes a processor 702 that may implement or execute machine readable instructions performing some or all of the methods, functions and other processes described herein. Commands and data from the processor 702 are communicated over a communication bus 704. The computer system also includes a main memory 706, such as a random access memory (RAM), where the machine readable instructions and data for the processor 702 may reside during runtime, and a secondary data storage 708, which may be non-volatile and stores machine readable instructions and data. The memory and data storage are examples of computer readable mediums. The memory 706 may include a STSD generation module 720 including machine readable instructions residing in the memory 706 during runtime and executed by the processor 702. The STSD generation module 720 may include the modules 102, 106, and 112 of the apparatus shown in FIG. 1.

The computer system 700 may include an I/O device 710, such as a keyboard, a mouse, a display, etc. The computer system may include a network interface 712 for connecting to a network. Other known electronic components may be added or substituted in the computer system.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. A method for synthetic time series data generation, the method comprising:
receiving empirical meter data for a plurality of users;
using the empirical meter data to estimate parameters of a Markov chain; and
using, by a processor, the Markov chain to generate synthetic time series data having statistical properties similar to the statistical properties of the empirical meter data.

2. The method of claim 1, wherein using the empirical meter data to estimate parameters of the Markov chain further comprises:
discretizing the empirical meter data into a predetermined number of states.

3. The method of claim 2, wherein using the empirical meter data to estimate is parameters of the Markov chain further comprises:
estimating stationary probabilities of the Markov chain, wherein the stationary probabilities for each state of the predetermined number of states correspond to an average time spent in the state.

4. The method of claim 2, wherein using the empirical meter data to estimate parameters of the Markov chain further comprises:
for each state of the predetermined number of states, using a density estimate to compute a probability density function (PDF) corresponding to the state.

5. The method of claim 4, wherein using the density estimate to compute the PDF corresponding to the state further comprises:
using a kernel density estimate to compute the PDF corresponding to the state.

6. The method of claim 5, wherein using the kernel density estimate to compute the PDF corresponding to the state further comprises:
using a binned kernel density estimate to compute the PDF corresponding to the state.

7. The method of claim 4, wherein using the Markov chain to generate the synthetic time series data further comprises:
selecting an initial state from the predetermined number of states;
selecting further states based on a transition probability matrix; and
generating a synthetic time series value by sampling the PDF.

8. The method of claim 7, wherein selecting the initial state of the predetermined number of states further comprises:
randomly selecting the initial state of the predetermined number of states.

9. The method of claim 1, wherein using the empirical meter data to estimate parameters of the Markov chain further comprises:
using a maximum likelihood estimation (MLE) to estimate a transition probability matrix of the Markov chain from the empirical meter data.

10. The method of claim 9, further comprising:
using Laplace smoothing to address sparsity in the transition probability matrix.

11. The method of claim 1, wherein the empirical meter data comprises time series values, the method further comprising:
including a factor in addition to the time series values in the Markov chain.

12. A synthetic time series data generation apparatus comprising:
a memory storing machine readable instructions to:
receive empirical meter data for a plurality of users;
use the empirical meter data to estimate parameters of a Markov chain by discretizing the empirical meter data into a predetermined number of states; and
use the Markov chain to generate synthetic time series data having statistical properties similar to the statistical properties of the empirical meter data; and
a processor to implement the machine readable instructions.

13. The synthetic time series data generation apparatus according to claim 12, wherein to use the empirical meter data to estimate parameters of the Markov chain, the machine readable instructions are further to:
for each state of the predetermined number of states, use a density estimate to compute a probability density function (PDF) corresponding to the state.

14. A non-transitory computer readable medium having stored thereon machine readable instructions to provide synthetic data generation, the machine readable instructions, when executed, cause a computer system to:
receive data;
use the data to estimate parameters of a Markov chain; and
use, by a processor, the Markov chain to generate the synthetic data.
